(19) United States
(12) Patent Application Publication
(10) Pub. No.: US 2024/0260145 A1
(43) Pub. Date: Aug. 1, 2024

(54) ELECTRIC RANGE AND CONTROL METHOD THEREFOR

(71) Applicant: COWAY CO., LTD., Gongju-si (KR)

(72) Inventors: Young Kook KIM, Seoul (KR); Yeon Soo SEONG, Seoul (KR); Young Ju KIM, Seoul (KR)

(73) Assignee: COWAY CO., LTD., Gongju-si (KR)

(21) Appl. No.: 18/565,773

(22) PCT Filed: May 23, 2022
(86) PCT No.: PCT/KR2022/007313

§ 371 Date: Nov. 30, 2023

(30) Foreign Application Priority Data
Jun. 3, 2021 (KR) 10-2021-0072373

(51) Int. Cl. H05B 6/06; H05B 6/04

(52) U.S. Cl. CPC H05B 6/06; H05B 6/04

(57) ABSTRACT

An electric range includes: an inverter for outputting high frequency power by switching direct current power according to a switching signal to be inputted; a heating unit including a working coil for performing induction heating by the high frequency power; a measurement unit for measuring the output of the induction heating; a controller; and an output unit for outputting a processing result of the controller. The controller determines a frequency of the switching signal on the basis of target power to control the output of the working coil, identifies a frequency band of the switching signal with respect to a target container to be inductively heated, generates suitability evaluation information about the container on the basis of the identified frequency band and the output of the induction heating measured by the measurement unit, and then controls that the information is outputted through the output unit.

### TECHNICAL FIELD

The present disclosure relates to an electric range for heating a container by induction heating and a method for controlling such an electric range.

### BACKGROUND ART

As is generally known, an electric range is an appliance that heats an electric heater or burner by using electric energy. Electric ranges offer advantages over gas ranges. Unlike gas ranges, there is no risk of gas leaks and explosions, and they are easy to clean and consume less energy due to their high thermal conductivity and are therefore becoming widely used as replacements for gas ranges.

Electric ranges are classified according to the method of heating: induction heaters which use induction heating: and radiant heaters which use electrical resistance. As electric power is applied to the induction heater, a high-frequency voltage of a certain magnitude is applied to a working coil, generating a magnetic field around the working coil. Magnetic lines in the generated induction magnetic field generate an eddy current inside the burner, and the burner is heated by this eddy current. In the case of the radiant heater, when a certain power is applied to a heating coil inside the burner, the heating coil emits high-temperature radiant heat by generating heat on its own, thus achieving heating.

Particularly, in the case of the induction heater which uses an induction magnetic field, there are large variations in efficiency depending on the characteristics of a target container to be inductively heated.

Thus, if an unsuitable container is placed on a burner, such as one made with a material not suitable for the heating method of the electric range, this can lead to problems like low output or inefficiency.

### Prior Art Document

(Patent Document) Korean Laid-Open Patent Publication NO. 10-2020-0141781 (filed on Dec. 21, 2020).

### DETAILED DESCRIPTION OF INVENTION

### Technical Problems

According to an embodiment, there is provided an electric range that generates and outputs evaluation information to check the suitability of a container, so that the user is prompted to use a container suitable for the electric range.

Technical objects to be achieved by the present disclosure are not limited to the aforementioned technical objects, and other technical objects not described above may be evidently understood by a person having ordinary skill in the art to which the present disclosure pertains from the following description.

### Technical Solution

According to a first aspect of the present disclosure, there is provided an electric range comprising: an inverter for outputting high frequency power by switching direct current power according to a switching signal to be inputted: a heating unit including a working coil for performing induction heating by the high frequency power: a measurement unit for measuring the output of the induction heating: a controller; and an output unit for outputting a processing result of the controller, wherein the controller is configured to determine a frequency of the switching signal on the basis of target power to control the output of the working coil, identify a frequency band of the switching signal with respect to a target container to be inductively heated, generate suitability evaluation information about the container on the basis of the identified frequency band and the output of the induction heating measured by the measurement unit, and then control that the information is outputted through the output unit.

The controller may calculate output efficiency based on the ratio between the output of the induction heating and the target power, calculate frequency efficiency based on the ratio between the identified frequency band and a preset frequency band, and generate suitability evaluation information about the target container based on the output efficiency and the frequency efficiency.

The controller may input the output efficiency and the frequency efficiency into a data table that includes a plurality of output efficiency values and a plurality of frequency efficiency values as factors and stores a plurality of result values corresponding to the factors, so as to generate result values corresponding to the output efficiency and the frequency efficiency, among the plurality of result values, as suitability evaluation information about the target container.

The preset frequency band may include a frequency at which the inverter has minimum switching loss when the target container is inductively heated based on the target power.

The electric range may further include an input unit for receiving selection information for one of a plurality of cooking modes, wherein the controller may generate suitability evaluation information about the container based on the output of the induction heating, the identified frequency band, and the selection information.

According to a second aspect of the present disclosure, there is provided a control method for an electric range, that is performed by a controller included in the electric range, the method including: outputting, to an inverter, a switching signal whose frequency is determined based on target power so that the inverter applies high frequency power to a working coil by switching direct current power according to the switching signal and thereby the working coil performs induction heating by the high frequency power; identifying a frequency band of the switching signal corresponding to a target container to be inductively heated; measuring the output of the induction heating; and generating and outputting suitability evaluation information about the target container on the basis of the output of the induction heating and the identified frequency band.

The generating and outputting of suitability evaluation information about the target container may include: calculating output efficiency based on the ratio between the output of the induction heating and the target power; calculating frequency efficiency based on the ratio between the identified frequency band and a preset frequency band; and generating suitability evaluation information about the target container based on the output efficiency and the frequency efficiency.

The generating of suitability evaluation information about the target container may include inputting the output efficiency and the frequency efficiency into a data table that contains a plurality of power ratio values and a plurality of frequency ratio values as factors and stores a plurality of result values corresponding to the factors, so as to generate result values corresponding to the output efficiency and the frequency efficiency, among the plurality of result values, as suitability evaluation information about the target container.

The preset frequency band may include a frequency at which the inverter has minimum switching loss when the target container is inductively heated based on the target power.

The control method may further include receiving selection information for one of a plurality of cooking modes prior to the performing of the induction heating, wherein the generating and outputting of suitability evaluation information about the target container may include generating suitability evaluation information about the container based on the output of the induction heating, the identified frequency band, and the selection information.

According to a third aspect of the present disclosure, there is provided a non-transitory computer-readable recording medium storing a computer program, the computer program including instructions that, when executed by a processor, cause the processor to perform the method described above.

### Effect of Invention

According to an embodiment of the present disclosure, evaluation information for checking the suitability of a container is generated and outputted. Therefore, the user can be prompted to use a container having characteristics suitable for the electric range by referring to container suitability evaluation information. Moreover, the user can be prompted to use a container having optimal characteristics for each cooking mode, by providing container suitability evaluation information which even takes into consideration the best container and/or heating condition corresponding to a selected cooking mode. As such, the use of the best container suited for an operation of the electric range improves the efficiency of the electric range.

### BRIEF DESCRIPTION OF THE DRAWINGS

FIG. 1 is a block diagram of an electric range according to an embodiment of the present disclosure.

FIG. 2 is a flowchart for illustrating a control method of an electric range according to a first embodiment of the present disclosure.

FIG. 3 is a flowchart for illustrating a process of generating container suitability information, in the control method of an electric range in FIG. 2.

FIG. 4 is a flowchart for illustrating a control method of an electric range according to a second embodiment of the present disclosure.

### BEST MODE FOR CARRYING OUT THE INVENTION

Advantages and features of the present disclosure and methods for achieving them will be made clear from embodiments described below in detail with reference to the accompanying drawings. The present disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. The present disclosure is merely defined by the scope of the claims.

The terms used in this specification will be briefly described, and the present disclosure will be described in detail.

The terms used in the disclosure are selected from among common terms that are currently widely used in consideration of their function in the disclosure. However, the terms may be different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

Throughout the specification, when a part “includes” an element, it is to be understood that the part additionally includes other elements rather than excluding other elements as long as there is no particular opposing recitation.

Also, as used herein, the term “unit” refers to a hardware component such as software, FPGA, or ASIC, and “unit” performs a certain role. However, “unit” is not meant to be limited to software or hardware. The “unit” may be configured to reside on an addressable storage medium and may be configured to reproduce one or more processors. Thus, as an example, “unit” includes components such as software components, object-oriented software components, class components and task components, processes, functions, attributes, procedures, subroutines, segments of program code, drivers, firmware, microcodes, circuits, data, databases, data structures, tables, arrays, and variables. The functions provided in the components and the “units” may be combined into a smaller number of components and “units” or further divided into additional components and “units”.

Embodiments of the present disclosure will be described in detail below with reference to the accompanying drawings so that those skilled in the art may easily practice the present disclosure. And, in the drawings, to clearly describe the present disclosure, portions not related to the description will be omitted.

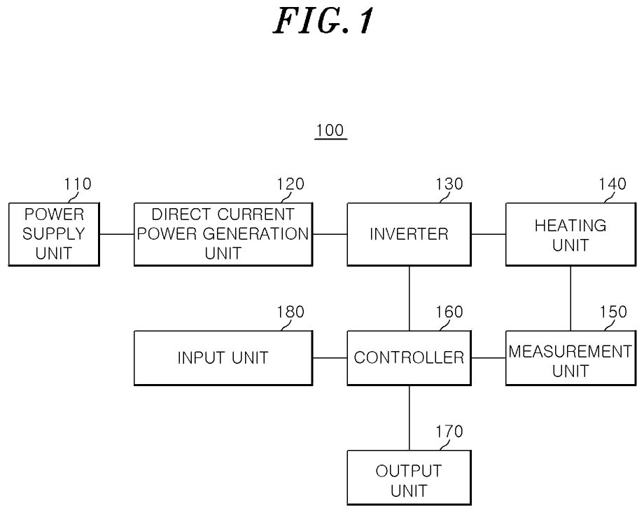

FIG. 1 is a block diagram of an electric range 100 according to an embodiment of the present disclosure.

Referring to FIG. 1, the electric range 100 includes an inverter 130, a heating unit 140, a measurement unit 150, a controller 160, and an output unit 170, and may further include an input unit 180. Also, the electric range 100 may further include a power supply unit 110 and a direct current power generation unit 120, which are for supplying power to the inverter 130.

The power supply unit 110 provides alternating current power to the direct current power generation unit 120. For example, the power supply unit 110 may provide commercial power to the direct current power generation unit 120.

The direct current power generation unit 120 generates direct current power required for the electric range 100 from the alternating current power provided from the power supply unit 110 and provides it to the inverter 130.

The inverter 130 outputs high frequency power to the heating unit 140 by switching the direct current power from the direct current power generation unit 120 according to a switching signal from the controller 160.

The heating unit 140 includes a burner including a working coil, and the working coil performs induction heating by means of the high frequency power from the inverter 130.

The measurement unit 150 measures the output of the induction beating by the heating unit 140 and provides a measurement result to the controller 160.

The controller 160 determines the frequency of the switching signal on the basis of target power to control the output of the working coil within the heating unit 140, identifies a frequency band of the switching signal with respect to a target container to be inductively heated, generates suitability evaluation information about the container on the basis of the identified frequency band and the output power of the induction heating measured by means of the measurement unit 150, and then outputs it through the output unit 170. For example, the controller 160 may calculate output efficiency based on the ratio between the output power of the induction heating and the target power, calculate frequency efficiency based on the ratio between the identified frequency band and a preset frequency band, and generate suitability evaluation information about the container based on the output efficiency and the frequency efficiency. For instance, the output efficiency and the frequency efficiency may be inputted into a data table that contains a plurality of output efficiency values and a plurality of frequency efficiency values as factors and stores a plurality of result values corresponding to these factors, so as to generate result values corresponding to the output efficiency and the frequency efficiency, among the plurality of result values, as suitability evaluation information about the container. Here, the target power may refer to a power intended to be reached to heat the container up to a desired temperature according to the cooking mode for a target to be heated, for example, food. The output power of the electric range required to reach the target power may vary with the container, and the ratio between the target power and the output power may be included, as the output efficiency, in the data table. Also, as the electric range is stably operated, the ratio between a frequency band with little switching Joss and the frequency band of a target container to be inductively heated by the electric range may be included, as the frequency efficiency, in table form, and the suitability evaluation information about the container generated based on the output efficiency and the frequency efficiency may be included in the data table. Here, the preset frequency band may include a frequency at which the inverter 130 has minimum switching loss when the target container is inductively heated based on the target power. The controller 160 may include a computing means such as a microprocessor, for performing various arithmetic operations to control the electric range 100.

The output unit 170 outputs processing results from the controller 160. For example, the output unit 170 may output processing results from the controller 160 in various formats including graphics by the control of the controller 160.

Moreover, in a case where a plurality of cooking modes are supported by the controller 160, the input unit 180 may receive selection information for one of the plurality of cooking modes. In this case, the controller 160 may generate suitability evaluation information about the container based on the output power of the induction heating, the identified frequency band, and the cooking mode selection information.

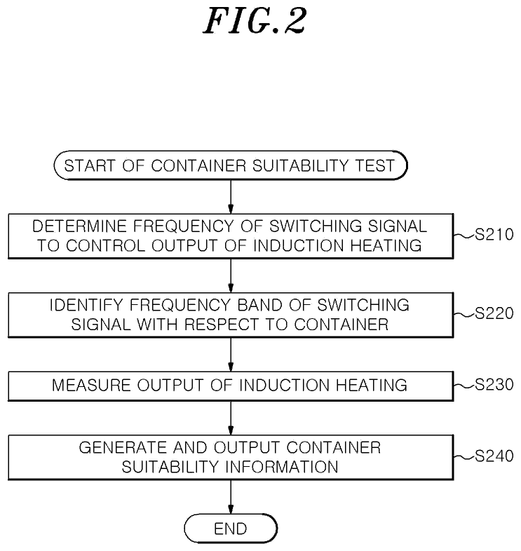

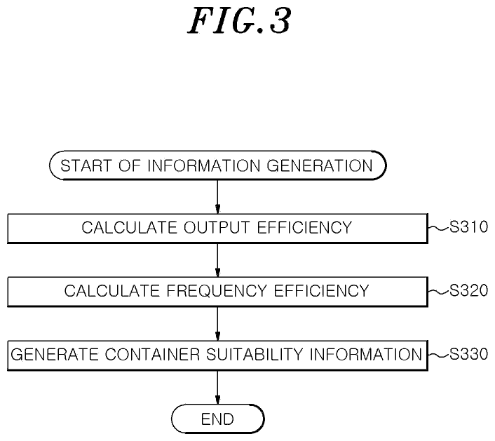

FIG. 2 is a flowchart for illustrating a control method of an electric range according to a first embodiment of the present disclosure. FIG. 3 is a flowchart for illustrating a process of generating container suitability information, in the control method of an electric range in FIG. 2.

Hereinafter, referring to FIGS. 1 to 3, a control method for the electric range 100 to be performed by the controller 160 included in the electric range 100 will be described in detail.

First, a process in which a burner and a container placed on the burner are heated by the electric range 100 will be described. The power supply unit 110 provides alternating current power to the direct current power generation unit 120, and the direct current power generation unit 120 generates direct current power required for the electric range 100 from the alternating current power provided from the power supply unit 110 and supplies it to the inverter 130. While the direct current power is being supplied, the inverter 130 outputs high frequency power to the heating unit 140 by switching the direct current power from the direct current power generation unit 120 according to a switching signal from the controller 160. Then, the working coil in the heating unit 140 performs induction heating by the high frequency power from the inverter 130.

During or prior to such a heating operation of the electric range 100, the controller 160 may start a container suitability test for checking the suitability of a container by selecting to start the test through the input unit 180 or the like, and generate and output container suitability evaluation information as a result of the test.

A process for testing container suitability will be described. The controller 160 determines the frequency of a switching signal provided to the inverter 130 on the basis of target power to control the output of the working coil within the heating unit 140 (S210).

Moreover, the controller 160 first identifies a frequency band of the switching signal with respect to a container to be inductively heated, in order to evaluate the suitability of the container. For example, the controller 160 may use ZVS (Zero-Voltage Switch) control when determining a turn-on timing for a switching element included in the inverter 130. For instance, the controller 160 may determine to turn on a switching element at a zero point by comparing a resonant voltage and a DC link voltage in a frequency single-ended topology, and determine the on time according to the target power. Incidentally, the output may be decreased or turned off even if the power actually transferred to the container does not reach the target power due to an over voltage protection and/or over current protection operation performed by the controller 160. Here, one cycle may be calculated in which the switching element is turned on at the zero point, the on time is maintained according to the target power, and then the resonant voltage is discharged again. By converting the calculated cycle back to a frequency, the frequency band of the switching signal with respect to the container may be identified (S220).

Moreover, during the heating operation of the electric range 110, the measurement unit 150 measures the output of the induction heating by the heating unit 140 and provides a measurement result to the controller 160 (S230).

Then, the controller 160 generates suitability evaluation information about the container on the basis of the output power of the induction heating measured by means of the measurement unit 150 and the frequency band identified in step S220, and outputs the generated container suitability evaluation information through the output unit 170 (S240).

The process shown in step S240 in which the controller 160 generates container suitability evaluation information will be described in further detail. The controller 160 calculates output efficiency first. For example, after a predetermined amount of time since the start of the induction beating by the heating unit 140, output efficiency may be calculated based on the ratio between the measurement result from the measurement unit 150 and the target power.

Also, the controller 160 calculates frequency efficiency. For example, frequency efficiency may be calculated based on the ratio between the frequency band identified in step S220 and a preset frequency band. Here, the preset frequency band may include a frequency at which the inverter 130 has minimum switching loss when a particular container is inductively heated based on the target power. As exemplified previously, when ZVS control is used on the switching element included in the inverter 130, the output may be decreased or turned off even if the power actually transferred to the container does not reach the target power due to an over voltage protection and/or over current protection operation. The higher the frequency, the lower the current, which, in turn, reduces the output of the heating unit 140 and increases the switching loss of the switching element, thus reducing the duration of the beating as well (S320).

Next, the controller 160 generates suitability evaluation information about the container based on the output efficiency calculated in step S310 and the frequency efficiency calculated in step S320. For example, the controller 160 sets criteria on the assumption that a standard container considering the size of a burner has 100% efficiency, and inputs the output efficiency calculated in step S310 and the frequency efficiency calculated in step S320 into a data table containing a plurality of output efficiency values and a plurality of frequency efficiency values as factors. Thus, one of a plurality of result values stored corresponding to these factors may be generated as suitability evaluation information about the container (S330).

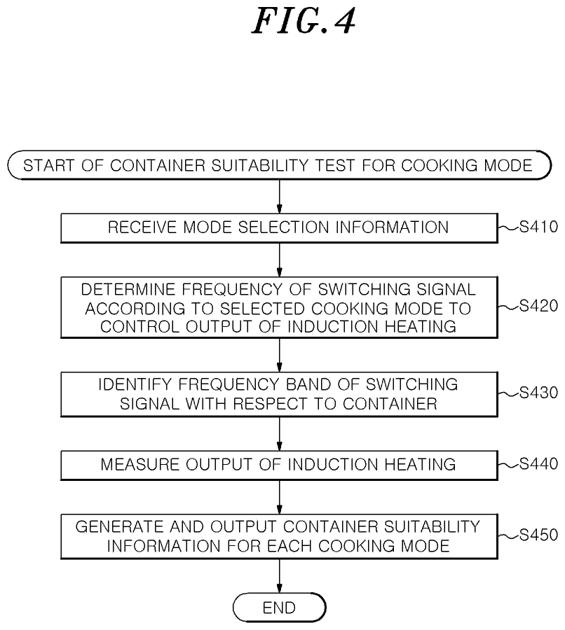

Meanwhile, the electric range 100 may support a plurality of cooking modes. For example, cooking modes such as pan, heating, simmer, keep warm, etc., provide heating conditions suitable for different cooking modes by varying the target power for each cooking mode. Incidentally, the suitability of a container or the quality of the outcome of heating may be affected much by each cooking mode. For example, if other types of container, other than a pan, is placed on a burner in the pan mode, this may cause degradation of the quality of the outcome of heating. According to the second embodiment of the present disclosure, suitability evaluation information about the container may be generated and outputted for each cooking mode. FIG. 4 is a flowchart for illustrating a control method of an electric range 100 according to a second embodiment of the present disclosure.

Referring to FIGS. 1 and 4, the user may enter selection information for a cooking mode through the input unit 180, and the entered selection information for the cooking mode is provided to the controller 160 (S410).

Then, as in step S210 explained previously with reference to FIG. 2, the controller 160 determines the frequency of a switching signal for the inverter 130 based on target power corresponding to the selected cooking mode to control the output of the working coil 140 according to the target power for the selected cooking mode (S420).

Also, as in step S220 explained previously with reference to FIG. 2, the controller 160 identifies a frequency band of the switching signal with respect to a container to be inductively heated in the cooking mode (S430).

In this case, as in step S230 explained with reference to FIG. 2, the measurement unit 150 measures the output of induction heating by the beating unit 140 and provides a measurement result to the controller 160 (S440).

Then, the controller 160 generates suitability evaluation information about the container for each cooking mode, on the basis of the output power of the induction heating measured by means of the measurement unit 150 and the frequency band identified in step S430, and outputs the generated container suitability evaluation information through the output unit 170. Here, the process in which the controller 160 generates and outputs container suitability evaluation information may be deemed similar or identical to step S240 explained previously with reference to FIG. 2, except that the process is performed according to the selected cooking mode (S450).

Meanwhile, each of the steps included in the control method for an electric range according to the foregoing embodiment may be implemented in a computer-readable recording medium that stores a computer program containing instructions for performing these steps.

As explained so far, according to an embodiment of the present disclosure, evaluation information for checking the suitability of a container is generated and outputted. Therefore, the user can be prompted to use a container having characteristics suitable for the electric range by referring to container suitability evaluation information. Moreover, the user may be prompted to use a container having optimal characteristics for each cooking mode, by providing container suitability evaluation information which even takes into consideration the best container and/or heating condition corresponding to a selected cooking mode. As such, the use of the best container suited for an operation of the electric range improves the efficiency of the electric range.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

1. An electric range comprising:
an inverter for outputting high frequency power by switching direct current power according to a switching signal to be inputted;
a heating unit including a working coil for performing induction heating by the high frequency power;
a measurement unit for measuring the output of the induction heating;
a controller; and
an output unit for outputting a processing result of the controller,
wherein the controller is configured to determine a frequency of the switching signal on the basis of target power to control the output of the working coil, identify a frequency band of the switching signal with respect to a target container to be inductively heated, generate suitability evaluation information about the container on the basis of the identified frequency band and the output of the induction heating measured by the measurement unit, and then control that the information is outputted through the output unit.

2. The electric range of claim 1, wherein the controller calculates output efficiency based on the ratio between the output of the induction heating and the target power, calculates frequency efficiency based on the ratio between the identified frequency band and a preset frequency band, and generates suitability evaluation information about the target container based on the output efficiency and the frequency efficiency.

3. The electric range of claim 2, wherein the controller inputs the output efficiency and the frequency efficiency into a data table that includes a plurality of output efficiency values and a plurality of frequency efficiency values as factors and stores a plurality of result values corresponding to the factors, so as to generate result values corresponding to the output efficiency and the frequency efficiency, among the plurality of result values, as suitability evaluation information about the target container.

4. The electric range of claim 2, wherein the preset frequency band includes a frequency at which the inverter has minimum switching loss when the target container is inductively heated based on the target power.

5. The electric range of claim 1, further comprising an input unit for receiving selection information for one of a plurality of cooking modes,
wherein the controller generates suitability evaluation information about the container based on the output of the induction heating, the identified frequency band, and the selection information.

6. A control method for an electric range, that is performed by a controller included in the electric range, the method comprising:
outputting, to an inverter, a switching signal whose frequency is determined based on target power so that the inverter applies high frequency power to a working coil by switching direct current power according to the switching signal and thereby the working coil performs induction heating by the high frequency power;
identifying a frequency band of the switching signal corresponding to a target container to be inductively heated;
measuring the output of the induction heating; and
generating and outputting suitability evaluation information about the target container on the basis of the output of the induction heating and the identified frequency band.

7. The control method of claim 6, wherein the generating and outputting of suitability evaluation information about the target container includes:
calculating output efficiency based on the ratio between the output of the induction heating and the target power;
calculating frequency efficiency based on the ratio between the identified frequency band and a preset frequency band; and
generating suitability evaluation information about the target container based on the output efficiency and the frequency efficiency.

8. The control method of claim 7, wherein the generating of suitability evaluation information about the target container includes inputting the output efficiency and the frequency efficiency into a data table that contains a plurality of power ratio values and a plurality of frequency ratio values as factors and stores a plurality of result values corresponding to the factors, so as to generate result values corresponding to the output efficiency and the frequency efficiency, among the plurality of result values, as suitability evaluation information about the container.

9. The control method of claim 7, wherein the preset frequency band includes a frequency at which the inverter has minimum switching loss when the target container is inductively heated based on the target power.

10. The control method of claim 6, further comprising receiving selection information for one of a plurality of cooking modes prior to the performing of the induction heating,
wherein the generating and outputting of suitability evaluation information about the target container includes generating suitability evaluation information about the container based on the output of the induction heating, the identified frequency band, and the selection information.

11. A non-transitory computer-readable recording medium storing a computer program, the computer program including instructions that, when executed by a processor, cause the processor to perform the method according to claim 6.
